(19) United States
(12) Patent Application Publication
(10) Pub. No.: US 2010/0090784 A1
(43) Pub. Date: Apr. 15, 2010

(54) Programmable Tunable Filter Waveguide

(76) Inventors: Jeffrey Brian Barner, Cary, NC (US); Delfin Chua, Vernon Hills, IL (US); Kent E. Peterson, Hoffman Estates, IL (US); Barbara Peterson, Hoffman Estates, IL (US)

Correspondence Address: TAROLLI, SUNDHEIM, COVELL & TUMMINO L.L.P., 1300 EAST NINTH STREET, SUITE 1700, CLEVEVLAND, OH, 44114, US

(21) Appl. No.: 12/249,505

(22) Filed: Oct. 10, 2008

(51) Int. Cl. H01P 1/207

(52) U.S. Cl. 333/209

(57) ABSTRACT

One embodiment of the present invention includes a waveguide. The waveguide comprises an elongated member having a conductive bottom surface and a hollow channel. The hollow channel is defined by a first conductive sidewall, a second conductive sidewall, and a conductive inner surface. The waveguide also comprises a plurality of conductive ridge portions projecting from the conductive inner surface and extending between the first conductive sidewall and the second conductive sidewall. The conductive ridge portions can partition the hollow channel into a plurality of hollow recesses. The waveguide further comprises a plurality of switches associated with each of at least one of the plurality of conductive ridge portions. At least one of the plurality of switches associated with a respective one of the plurality of conductive ridge portions can be activated to couple the respective one of the plurality of conductive ridge portions to the conductive bottom surface.

### TECHNICAL FIELD

The present invention relates to wave communications and, more particularly, to a programmable tunable filter waveguide.

### BACKGROUND OF THE INVENTION

The technology of information transfer continues to increase rapidly due to the climbing demand for wireless applications. Additionally, systems such as radar, signal intelligence (SigInt), and electronic warfare (EW) systems have ever increasing requirements for bandwidth while reducing size, weight and power. All of these micrometer (μm) or millimeter (mm) wave transceiver systems are typically equipped with antenna systems that include a configuration of antenna feeds that use downlink signals and/or receive uplink signals. In particular, as the demand for wireless communication applications increases, so also does the demand for systems to be capable of transmitting and/or receiving respective signals having wider bandwidth capacity. Furthermore, as systems are typically not reconfigurable once put into service, systems are typically equipped with an arrangement of components that are capable of handling only a fixed range of bandwidths. In particular, radar, SigInt, and EW systems are being placed on unmanned vehicles, both aerial and ground-based, with continuously decreasing size, where there are high electrical performance requirements with very little tolerance to weight and power consumption.

Typically, a μm- and/or mm-wave signal received by the system is propagated to channelized filter banks prior to being frequency downconverted and digitized. The channelized filter banks include a plurality of different band-pass, high-pass and/or low-pass filters into which the μm- and/or mm-wave signal is switched based on the frequency pass-band intended to be received by the system. Therefore, a received μm- and/or mm-wave signal is switched to a desired filter bank in order to filter unwanted signals from being digitized in the receiver system. A system may likewise switch an outgoing modulated signal between a plurality of channelized filter banks prior to transmitting a μm- and/or mm-wave signal such that only desired signals are transmitted.

By switching the transmitted and received μm- and/or mm-wave signals between the channelized filter banks, the system can be configured to modulate and demodulate wave signals occupying a number of channels of fixed bandwidths. However, because a given system may be configured to provide μm- and/or mm-wave signals over a broad range of frequencies, the system may require a large number of channelized filter banks, as well as a large number of switch manifolds to provide the transmitted and received μm- and/or mm-wave signals to the filter banks. The large number of channelized filter banks, switches, and other associated hardware, such as the interconnecting transmission lines, can occupy an excessive amount of the limited available space in a system. In addition, the switches that direct the μm- and/or mm-wave signal from one transmission line to a multitude of output transmission lines that are coupled to the filter banks can substantially affect an acquisition time of received μm- and/or mm-wave signals based on a slow speed of switching, and can also introduce excess signal loss. This can be particularly true in systems where the power level of the signals are high, such as on the order of one or more Watts, that require the use of switch technologies that can handle the higher power but have inherently slower switching speeds.

### SUMMARY OF THE INVENTION

One embodiment of the present invention includes a waveguide. The waveguide comprises an elongated member having a conductive bottom surface and a hollow channel. The hollow channel is defined by a first conductive sidewall, a second conductive sidewall, and a conductive inner surface. The waveguide also comprises a plurality of conductive ridge portions projecting from the conductive inner surface and extending between the first conductive sidewall and the second conductive sidewall. The plurality of conductive ridge portions can be conductive and can partition the hollow channel into a plurality of hollow recesses. The waveguide further comprises a plurality of switches associated with each of at least one of the plurality of conductive ridge portions. At least one of the plurality of switches associated with a respective one of the plurality of conductive ridge portions can be activated to couple the respective one of the plurality of conductive ridge portions to the conductive bottom surface.

Another embodiment of the present invention includes a method for filtering a wave signal in an elongate waveguide structure. The method comprises determining a desired frequency pass-band for the wave signal. The method also includes selecting at least one pair of a plurality of conductive ridge portions disposed along a longitudinal surface of the elongate waveguide structure. The selected at least one pair of the plurality of conductive ridge portions can correspond to a respective at least one resonator pole based on a physical separation of the at least one pair of the plurality of conductive ridge portions relative to a wavelength of the wave signal that is associated with the respective at least one resonator pole. The respective at least one resonator pole can correspond to a respective at least one frequency within the desired frequency pass-band. The method also comprises activating a plurality of switches configured to conductively couple the selected at least one pair of the plurality of conductive ridge portions to a conductive outer surface of the elongate waveguide structure.

Another embodiment of the present invention includes a wave signal waveguide. The waveguide comprises means for slowing propagation of a wave signal from a first end of the waveguide to a second end of the waveguide. The waveguide also comprises means for switchably generating at least one resonator pole associated with a respective at least one frequency of the wave signal. The at least one resonator pole can define a frequency pass-band for the wave signal.

### BRIEF DESCRIPTION OF THE DRAWINGS

FIG. 1 illustrates an example of a micrometer (μm) and/or millimeter (mm)-wave receive and/or transmit system in accordance with an aspect of the invention.

FIG. 2 illustrates an example of an exploded view of a programmable tunable filter waveguide in accordance with an aspect of the invention.

FIG. 3 illustrates an example of a schematic representation of a portion of a programmable tunable filter waveguide in accordance with an aspect of the invention.

FIG. 4 illustrates an example of different configurations of a programmable tunable filter waveguide in accordance with an aspect of the invention.

FIG. 5 illustrates an example of a frequency response graph of the programmable tunable filter waveguide of the example of FIG. 4 in accordance with an aspect of the invention.

FIG. 6 illustrates an example of a configuration of a programmable tunable filter waveguide in accordance with an aspect of the invention.

FIG. 7 illustrates diagrammatic examples of a programmable tunable filter waveguide in accordance with an aspect of the invention.

FIG. 8 illustrates an example of a method of filtering signals in accordance with an aspect of the invention.

### DETAILED DESCRIPTION OF INVENTION

The present invention relates to micrometer (μm) and/or millimeter (mm)-wave systems that employ filters to select frequencies of interest for communication, radar, signal intelligence (SigInt), and electronic warfare (EW) applications, either in the receiver or transmit components. More particularly, this invention applies to replacing such filters with a programmable tunable miniature waveguide filter. The waveguide can be a ridged waveguide having a slow-wave configuration that includes a plurality of conductive ridge portions. The slow-wave configuration of a waveguide, including the plurality of conductive ridge portions, is described in detail in U.S. Pat. No. 7,023,302 to Peterson, et al., which is herein incorporated in its entirety by reference. At least some of the plurality of conductive ridge portions can include a plurality of switches. The plurality of switches for a given one of the plurality of conductive ridge portions can be activated to conductively couple the conductive ridge portion to a respective plurality of conductive shunts. The conductive shunts can be coupled to a conductive outer surface of the waveguide. The coupling of a given conductive ridge portion to one or more of the conductive shunts can affect the resonant coupling of a wave signal propagating through the waveguide. Therefore, by selecting specific conductive ridge portions and a number of switches to be activated to couple the specific conductive ridge portions to the conductive shunts, one or more resonator poles for specific frequencies can be formed on the waveguide. The one or more resonator poles can thus define a frequency pass-band for the μm- and/or mm wave signal propagating through the waveguide.

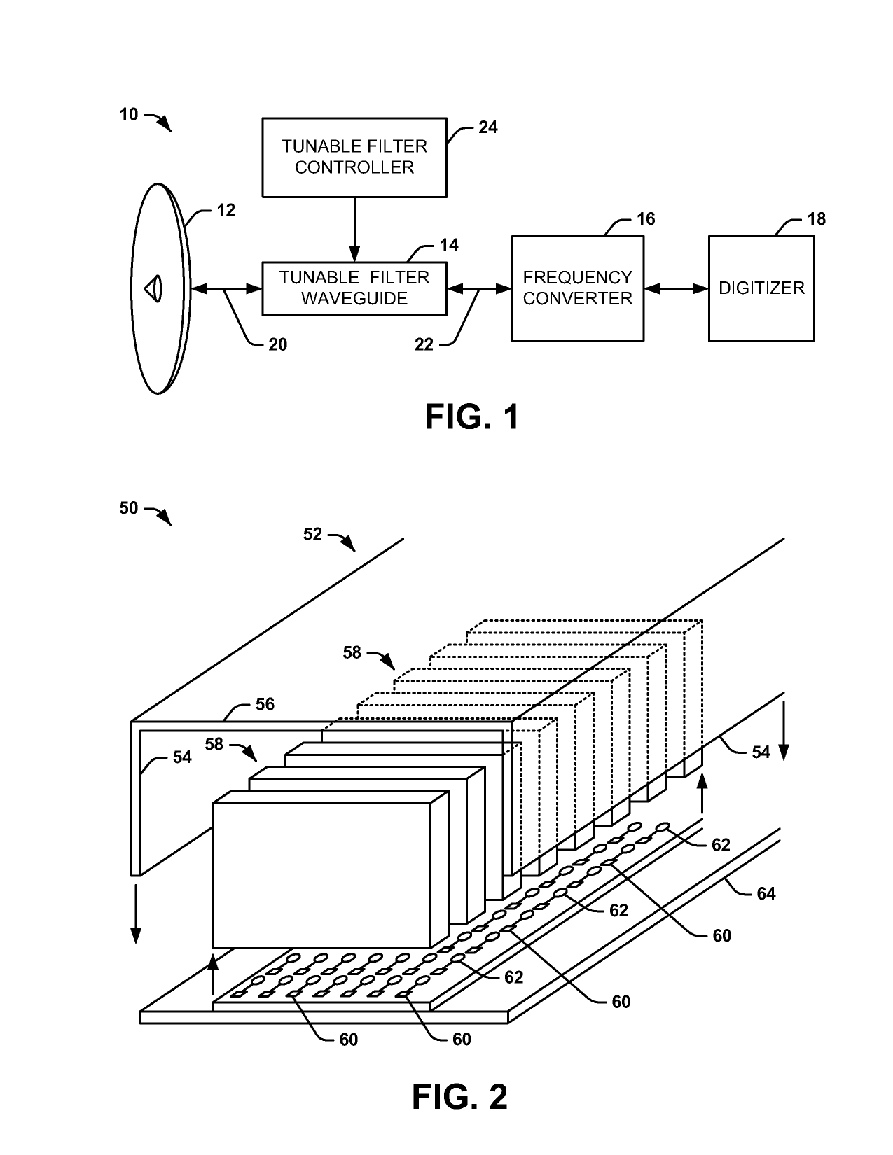

FIG. 1 illustrates an example of a wave signal receive and/or transmit system 10 in accordance with an aspect of the invention. The wave signal receive and/or transmit system 10 could be implemented on a satellite, or any of a variety of other μm and/or mm-wave devices configured to transmit and receive wave signals, such as μm and/or mm-wave signals. The wave signal receive and/or transmit system 10 includes an antenna 12 configured to transmit and receive the signals. The signals could include μm and/or mm-wave signals in a frequency range of, for example, approximately 3 GHz to approximately 900 GHz.

Signals that are received at the antenna 12 are input to a tunable filter waveguide 14. The tunable filter waveguide 14 can be a slow-wave ridged waveguide that is configured as a programmable band-pass filter the received signal. The tunable filter waveguide 14 provides the band-pass filtered wave signal to a frequency converter 16 that is configured to downconvert the wave signal to a baseband signal, from which the baseband signal is provided to a digitizer 18. The digitizer 18 is configured to convert the baseband signal into digitized spectral content, such that the signal can be provided to a controller or any of a variety of additional hardware for which the spectral content of the signal is intended. For example, the spectral content of the signal could include control instructions or could be data intended for re-transmission.

The tunable filter waveguide 14 can be configured as a slow-wave waveguide element that is interposed between a first transmission medium 20 and a second transmission medium 22. As an example, the first transmission medium 20 and the second transmission medium 22 can include any of a variety of different types of waveguides, such as a miocrostrip-line, coplanar strip-line, suspended strip-line, strip-line waveguide, rectangular waveguide, or ridged waveguide. As is explained in greater detail below, the tunable filter waveguide 14 can be programmable configured to include one or more resonator poles that define a given frequency pass-band for the received wave signal. As such, the wave signal receive and/or transmit system 10 includes a tunable filter controller 24 that is configured to control the frequency pass-band of the tunable filter waveguide 14.

As an example, the tunable filter waveguide 14 can include a plurality of switches that are activated to conductively couple two or more conductive ridge portions of the slow-wave waveguide element of the tunable filter waveguide 14 to an outside conductive surface of the tunable filter waveguide 14. Each of the plurality of switches can be implemented as rapid switching field effect transistors, such as switches in a monolithic microwave integrated circuit (MMIC). The tunable filter controller 24 can control the state of each of the switches. As such, by conductively coupling the two or more conductive ridge portions to the outside conductive surface, a resonant coupling associated with the given two or more conductive ridge portions of the tunable filter waveguide 14 can be decreased with respect to the signal propagating through the tunable filter waveguide 14. The two or more conductive ridge portions that are selected to be coupled to the outside surface can be predetermined to generate one or more resonator poles associated with one or more respective frequencies within a desired frequency pass-band.

The tunable filter controller 24 can also control the number of switches per conductive ridge portion that are activated to selectively control the amount of resonant coupling of each of the resonator poles. For example, the tunable filter controller 24 can activate more switches for a given conductive ridge portion to increase the conductive coupling of the given conductive ridge portion to the outside conductive surface, thus decreasing the amount of resonant coupling of the associated resonator poles formed by the given conductive ridge portion. Conversely, the tunable filter controller 24 can activate less switches for a given conductive ridge portion to decrease the conductive coupling of the given conductive ridge portion to the outside conductive surface, thus increasing the amount of resonant coupling of the associated resonator poles formed by the given conductive ridge portion. The tunable filter controller 24 can also control the switches to adjust the input and output impedances of the tunable filter waveguide 14, such that the input and output impedances of the tunable filter waveguide 14 can be substantially matched to the first transmission medium 20 and the second transmission medium 22, respectively. Furthermore, the tunable filter controller 24 can be configured to switch between several different switching configurations, such that the tunable filter waveguide 14 can be configured to switch between several different predetermined frequency pass-bands based on commands received from the tunable filter controller 24.

By controlling the switches of the tunable filter waveguide 14 to form resonator poles that define a frequency pass-band, the tunable filter waveguide 14 is thus programmable configured as a bandpass filter. However, the configuration of the resonator poles formed on the tunable filter waveguide 14 can also result in the passing of harmonic frequencies of the frequency pass-band of the signal. Therefore, the tunable filter waveguide 14 can also be configured to include a plurality of ridge coupling switches. The ridge coupling switches can be controlled by the tunable filter controller 24 to conductively couple adjacent conductive ridge portions of the tunable filter waveguide 14 together to simulate a non-slow-wave ridged waveguide portion. One or more of the simulated non-slow-wave ridged waveguide portions can be interleaved with the slow-wave waveguide structure, such that the one or more simulated non-slow-wave ridged waveguide portions form a low-pass filter. Therefore, harmonic frequencies of the frequency pass-band can be filtered from the signal propagating through the tunable filter waveguide 14.

As is demonstrated in the example of FIG. 1, the tunable filter waveguide 14 can be programmed by the tunable filter controller 24 to filter any of a variety of frequency pass-bands of the received or transmitted signal. Therefore, a single one of the tunable filter waveguide 14 can be used to replace bulky and expensive sets of channelized filter banks that would be necessary to accomplish filtering of similar frequency pass-band ranges. Because the tunable filter waveguide 14 may occupy little more space than a typical single filter in a filter bank, the available space on a satellite or other structure that implements the wave signal receive and/or transmit system 10 can be greatly increased. In addition, because the signal does not propagate through physical switches, such as can be implemented in typical channelized filter banks, the signal is not subject to switching losses by being switched between different channelized filter banks. Accordingly, the signal power can be improved by approximately 10 dB over that of traditional channelized filter bank implementations. Also, because the switches can be implemented as rapid switching MMIC switches, the tunable filter waveguide 14 can be switched between different frequency pass-bands without substantially affecting acquisition time. Furthermore, since the plurality of switches are distributed in the programmable waveguide filter structure, the power handling requirements on any individual switch is substantially reduced.

It is to be understood that the wave signal receive and/or transmit system 10 is not intended to be limited to the example of FIG. 1. Specifically, the example of FIG. 1 demonstrates a very simplified example of a wave transmit and/or receive system, such that the wave signal receive and/or transmit system 10 can include any of a variety of additional components that have been omitted for the sake of simplicity and ease of explanation. In addition, it is to be understood that the components of the wave signal receive and/or transmit system 10 are not intended to be limited solely to received signals, as described above, but that the components of the wave signal receive and/or transmit system 10, including the tunable filter waveguide 14 and tunable filter controller 24, can be implemented for transmitted signals, as well.

FIG. 2 illustrates an example of an exploded view of a programmable tunable filter waveguide 50 in accordance with an aspect of the invention. The programmable tunable filter waveguide 50 can be substantially similar to the tunable filter waveguide 14 in the example of FIG. 1. Therefore, reference is to be made to the example of FIG. 1 in the discussion of the example of FIG. 2. The programmable tunable filter waveguide 50 can be fabricated in any of a variety of manners, such as through a micromachined etching process. Therefore, the components of the programmable tunable filter waveguide 50 can be formed from a substrate, such as silicon, that can be plated with a conductive material, such as gold.

The programmable tunable filter waveguide 50 includes a conductive straight ridged waveguide structure 52. The conductive straight ridged waveguide structure 52 includes a pair of conductive sidewalls 54 and a conductive top portion 56. The conductive sidewalls 54 and the conductive top portion 56 define a hollow channel along the longitudinal length of the programmable tunable filter waveguide 50. The programmable tunable filter waveguide 50 also includes a plurality of conductive ridge portions 58. The conductive ridge portions 58 can be formed integral with the conductive top portion 56 and perpendicular with the conductive sidewalls 54, and can extend along the entire length of the programmable tunable filter waveguide 50. Thus, the conductive ridge portions 58 can be arranged such that a hollow recess is formed in-between each of conductive ridge portions 58. Accordingly, the conductive ridge portions 58 form a slow-wave structure in the conductive straight ridged waveguide structure 52.

The programmable tunable filter waveguide 50 also includes a plurality of switches 60 coupled to a plurality of conductive shunts 62. The switches 60 and the conductive shunts 62 can be formed in an integral layer that is coupled to a bottom surface of the conductive ridge portions 58, such that the switches 60 can be implemented as MMIC switches. In addition, each of the conductive shunts 62 can be conductively coupled to a conductive bottom surface 64 of the programmable tunable filter waveguide 50, which could also be formed integral with the switches 60 and the conductive shunts 62. The switches 60 and the conductive shunts 62 can be configured in rows, such that each row corresponds to a given one of the conductive ridge portions 58, with each of the switches 60 in a given row being coupled to one of the conductive ridge portions 58. Therefore, a given switch can be activated to conductively couple a given one of the conductive ridge portions 58 to a respective one of the conductive shunts 62. It is to be understood that the programmable tunable filter waveguide 50 could be configured such that not all of the conductive ridge portions 58 are coupled to switches 60. For example, some of the conductive ridge portions 58 may not ever be coupled to the conductive bottom surface 64 depending on the desired frequencies within the frequency pass-band, as described in greater detail below.

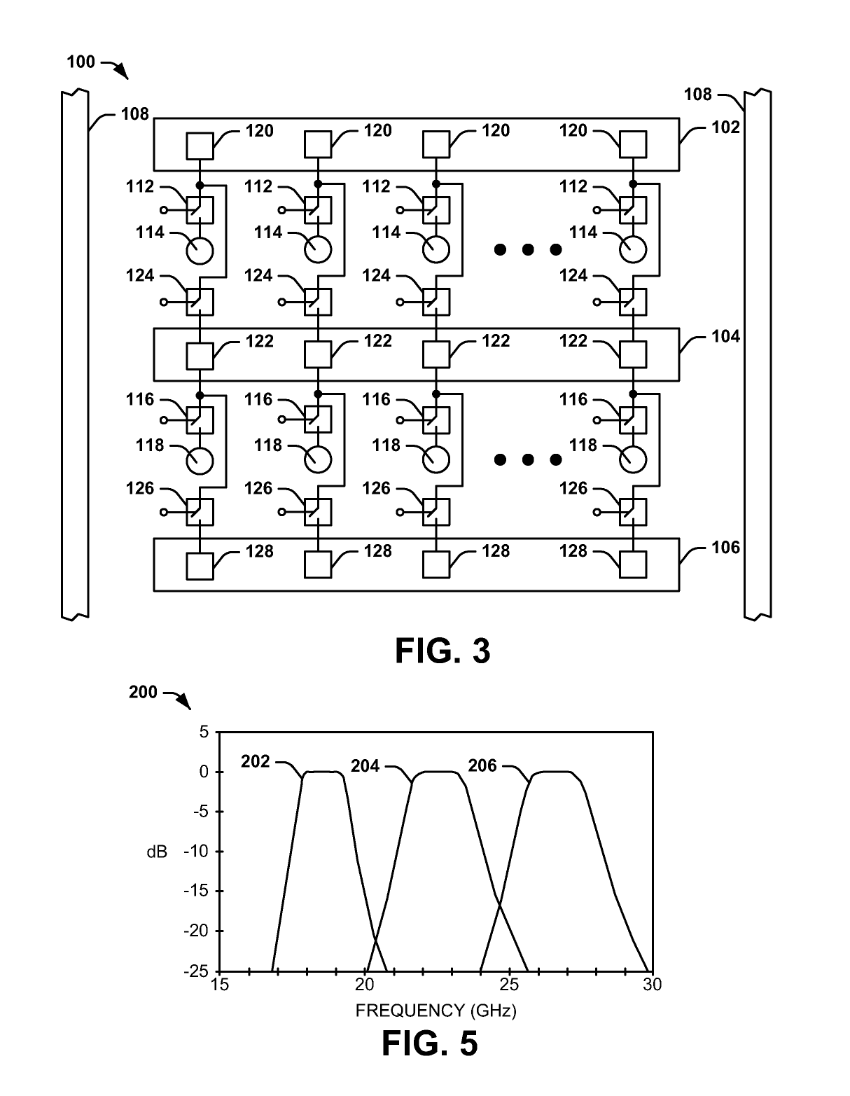

As an example, each of the conductive ridge portions 58 can be coupled to a group of, for example, between four and eight switches 60, demonstrated as seven in the example of FIG. 2, with each of the switches 60 being coupled to a respective one of the conductive shunts 62. The conductive shunts 62 in each of the rows can be arranged in the hollow recesses between the conductive ridge portions 58, such that the conductive ridge portions 58 can be conductively coupled to the conductive shunts 62 through a lateral conductive via (not shown), as demonstrated in more detail in the example of FIG. 3 below. Therefore, parasitic effects associated with the conductive shunts 62 that could provide interference on the signal propagating through the programmable tunable filter waveguide 50 can be substantially reduced. As a result of the arrangement of the switches 60 and the conductive shunts 62, the tunable filter controller 24 can control the activation state of each of the switches 60 separately to conductively couple one or more of the conductive ridge portions 58 to the conductive bottom surface 64 via one or more of the switches 60 and conductive shunts 62 in a respective one or more of the rows.

As described above, two or more of the conductive ridge portions 58 can be selected to be coupled to the conductive bottom surface 64 to generate one or resonator poles associated with one or more respective frequencies within a desired frequency pass-band. For example, a resonator pole for a frequency having an associated wavelength λ can be formed by coupling two of the conductive ridge portions 58 that are separated relative to each other by a length of approximately λ/2 to the conductive bottom surface 64. Based on the number of the switches 60 that are activated to couple the respective two or more of the conductive ridge portions 58 to the conductive bottom surface 64, the amount of resonant coupling of the signal to the resonator poles can be controlled. For example, the more switches 60 that are activated for a given conductive ridge portion 58, the more the conductive coupling of the given conductive ridge portion 58 to the conductive bottom surface 64 is increased, and thus the more the resonant coupling of the associated resonator poles formed by the given conductive ridge portion 58 is decreased. In addition, as also described above, the switches 60 can also be controlled to adjust the input and output impedances of the programmable tunable filter waveguide 50, such that the input and output impedances of the programmable tunable filter waveguide 50 can be substantially matched to the transmission mediums that are coupled to both ends of the programmable tunable filter waveguide 50.

FIG. 3 illustrates an example of a schematic representation of a portion of a programmable tunable filter waveguide 100 in accordance with an aspect of the invention. The portion of the programmable tunable filter waveguide 100 can be substantially similar to the programmable tunable filter waveguide 50 in the example of FIG. 2. Therefore, reference is to be made to the example of FIG. 2 in the discussion of the example of FIG. 3.

The portion of the programmable tunable filter waveguide 100 demonstrates a first conductive ridge portion 102, a second conductive ridge portion 104, and a third conductive ridge portion 106 arranged perpendicular between a first conductive sidewall 108 and a second conductive sidewall 110. The portion of the programmable tunable filter waveguide 100 also includes a first plurality of switches 112 that are each configured to conductively couple the first conductive ridge portion 102 to a respective one of a first plurality of conductive shunts 114. The portion of the programmable tunable filter waveguide 100 further includes a second plurality of switches 116 that are each configured to conductively couple the second conductive ridge portion 102 to a respective one of a second plurality of conductive shunts 118. The first conductive ridge portion 102 is coupled to the switches 112 through conductive compressible stud bumps 120, which could be fabricated from gold. Similarly, the second conductive ridge portion 104 is coupled to the switches 116 through conductive compressible stud bumps 122. The conductive shunts 114 are fabricated in a hollow recess formed between the first conductive ridge portion 102 and the second conductive ridge portion 104, and the conductive shunts 118 are fabricated in a hollow recess formed between the second conductive ridge portion 104 and the third conductive ridge portion 106. Therefore, parasitic effects associated with the conductive shunts 114 and 118 that could provide interference on the signal propagating through the programmable tunable filter waveguide in which the portion 100 is included can be substantially reduced.

Similar to as described above, the activation state of each of the switches 112 can be separately controlled to conductively couple the first conductive ridge portion 102 to a conductive outer surface, such as the conductive bottom surface 64 in the example of FIG. 2, via the lateral conductive coupling of the compressible stud bumps 120 to the conductive shunts 114. The amount of conductive coupling, and thus the inversely proportional resonant coupling of a signal to one or more resonator poles formed by the coupling of the conductive ridge portion 102 to the conductive shunts 114, can be controlled based on the number of the switches that are activated. For example, the greater the number of the switches 112 that are activated, the greater the conductive coupling of the first conductive ridge portion 102 to the conductive outer surface, and thus the less the resonant coupling of the associated resonator poles formed by the coupling of the first conductive ridge portion 102. In addition, because the energy of a given signal is greatest along a central axis of a slow-wave ridged waveguide, the switches 112 that are nearest the center of the first conductive ridge portion 102 have the greatest effect on the resonant coupling. Thus, the amount of conductive coupling, and thus also resonant coupling, can be controlled based on the location of the switches 112 that are activated to couple the first conductive ridge portion 102 to the conductive shunts 114. In a like manner, the activation state of each of the switches 116 can be separately controlled to conductively couple the second conductive ridge portion 104 to a conductive outer surface via the lateral conductive coupling of the compressible stud bumps 122 to the conductive shunts 118, such that conductive and resonant coupling of the second conductive ridge portion 104 can also be controlled.

In addition to the switches 112 and 116, the portion of the programmable tunable filter waveguide 100 demonstrates a first plurality of ridge connection switches 124 configured to conductively couple the compressible stud bumps 120 and the compressible stud bumps 122. Thus, the first ridge connection switches 124 are configured to conductively couple the adjacent first conductive ridge portion 102 and second conductive ridge portion 104. Likewise, the portion of the programmable tunable filter waveguide 100 demonstrates a second plurality of ridge connection switches 126 configured to conductively couple the compressible stud bumps 122 and a plurality of compressible stud bumps 128 that are included in the conductive ridge portion 106. Thus, the second ridge connection switches 126 are configured to conductively couple the adjacent second conductive ridge portion 104 and third conductive ridge portion 106. As described in greater detail below, by conductively coupling adjacent conductive ridge portions, the physical slow-wave waveguide structure can be reconfigured to simulate a non-slow-wave ridged waveguide structure. One or more simulated non-slow-wave ridged waveguide portions that are interleaved with slow-wave waveguide portions of a given programmable tunable filter waveguide can thus be configured as a series-connected low-pass filter. Therefore, undesired harmonic frequencies associated with the desired frequency pass-band can be filtered from the signal. The number of the ridge connection switches 124 or 126 that are activated at an end of a series of coupled adjacent conductive ridge portions can adjust the length of the simulated non-slow-wave ridged waveguide structure.

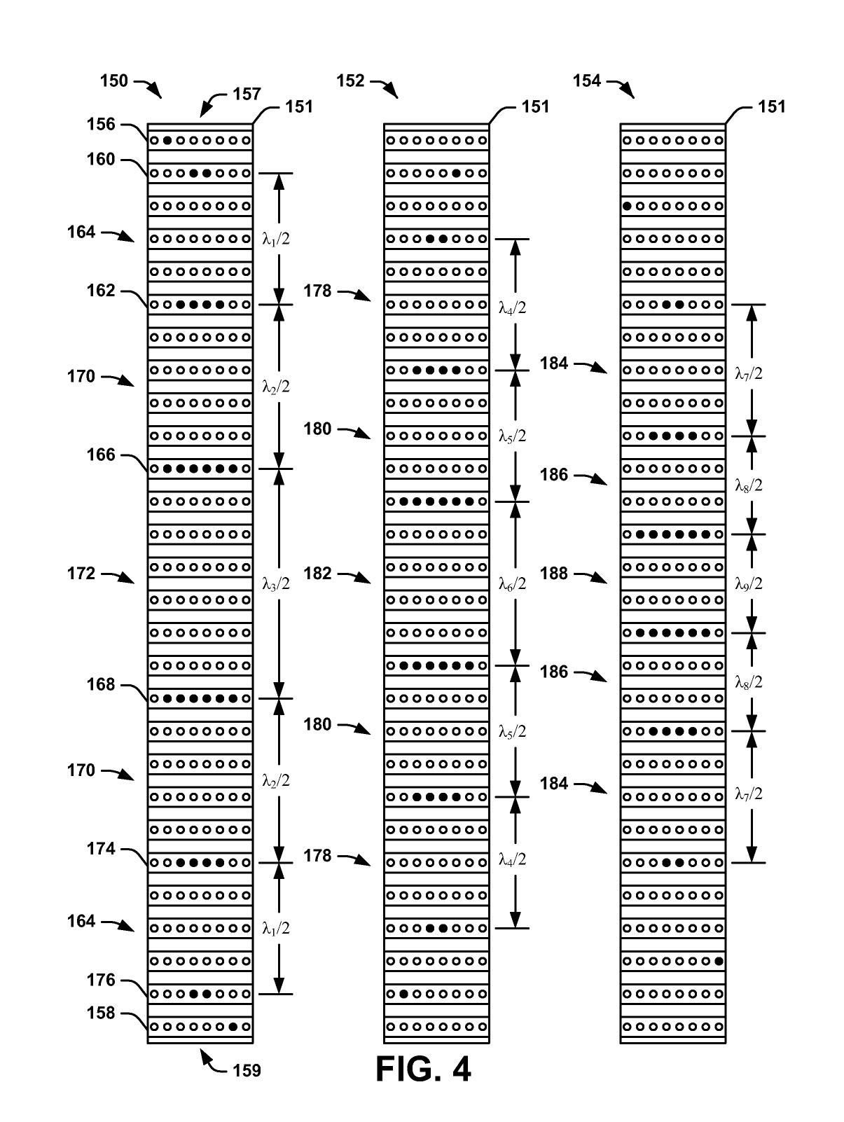

FIG. 4 illustrates an example of a first configuration 150, a second configuration 152, and a third configuration 154 of a programmable tunable filter waveguide 151 in accordance with an aspect of the invention. The programmable tunable filter waveguide 151 of which the first configuration 150, the second configuration 152, and the third configuration 154 represent can be substantially similar to the programmable tunable filter waveguide 50 in the example of FIG. 2. Therefore, reference is to be made to the example of FIG. 2 in the discussion of the example of FIG. 4.

The first configuration 150 of the programmable tunable filter waveguide 151 includes a first conductive ridge portion 156 at a first end 157 of the programmable tunable filter waveguide 151 and a second conductive ridge portion 158 at a second end 159 of the programmable tunable filter waveguide 151. Each of the first conductive ridge portion 156 and the second conductive ridge portion 158 have a single switch activated. It is to be understood that, in the example of FIG. 4, an activated switch is demonstrated as a solid black circle, and a deactivated switch is demonstrated as an open circle. Thus, both the first conductive ridge portion 156 and the second conductive ridge portion 158 may be weakly conductively coupled to a conductive outer surface, such as the conductive bottom surface 64 in the example of FIG. 2, and thus very strongly resonantly coupled. The single switch coupling of the first conductive ridge portion 156 and the second conductive ridge portion 158 may be implemented to substantially match an impedance of the first end 157 and the second end 159, respectively, of the programmable tunable filter waveguide 151 to respective connected transmission media.

The first configuration 150 of the programmable tunable filter waveguide 151 also includes a third conductive ridge portion 160 having two switches activated and a fourth conductive ridge portion 162 having four switches activated. Thus, the third conductive ridge portion 160 is more strongly conductively coupled than the first conductive ridge portion 156, and the fourth conductive ridge portion 162 is more strongly conductively coupled than the third conductive ridge portion 160. The third conductive ridge portion 160 and the fourth conductive ridge portion 162 are separated by a length of approximately λ₁/2. Therefore, the third conductive ridge portion 160 and the fourth conductive ridge portion 162 form a resonator pole 164 for a frequency having a corresponding wavelength of approximately λ₁.

The first configuration 150 of the programmable tunable filter waveguide also includes a fifth conductive ridge portion 166 and a sixth conductive ridge portion 168 each having six switches activated. Thus, the fifth and sixth conductive ridge portions 166 and 168 are the most strongly conductively coupled of the conductive ridge portions, and thus also the least resonantly coupled. The fourth conductive ridge portion 162 and the fifth conductive ridge portion 166 are separated by a length of approximately λ₂/2. Likewise, the fifth conductive ridge portion 166 and the sixth conductive ridge portion 168 are separated by a length of approximately λ₃/2. Therefore, the fourth and fifth conductive ridge portions 162 and 166 form a resonator pole 170 for a frequency having a corresponding wavelength of approximately λ₂, and the fifth and sixth conductive ridge portions 166 and 168 form a resonator pole 172 for a frequency having a corresponding wavelength of approximately λ₃. Accordingly, the first configuration 150 of the programmable tunable filter waveguide has a frequency pass-band for a signal that is defined by the series connection of the three resonator poles 164, 170, and 172.

As described above, the conductive ridge portion 168 is highly conductively coupled. As a result, the high conductive coupling at the conductive ridge portion 168 has a substantial effect on the impedance of the programmable tunable filter waveguide 151. Therefore, additional switches for additional conductive ridge portions may be activated to further affect the impedance of the programmable tunable filter waveguide 151, such that the impedance at the first end 157 can be substantially balanced relative to the second end 159. Therefore, the first configuration 150 of the programmable tunable filter waveguide 151 includes a seventh conductive ridge portion 174 having four switches activated and an eighth conductive ridge portion 176 having two switches activated.

The sixth conductive ridge portion 168 and the seventh conductive ridge portion 174 are separated by a length of approximately λ₂/2, and the seventh conductive ridge portion 174 and the eighth conductive ridge portion 176 are separated by a length of approximately λ₁/2. The separation of the sixth conductive ridge portion 168 and the seventh conductive ridge portion 174 is therefore approximately the same as the separation of the fourth conductive ridge portion 162 and the fifth conductive ridge portion 166. Therefore, the resonator pole 170 includes two portions that are symmetrical about the resonator pole 172, with each of the portions having resonant couplings that are also symmetrical about the resonator pole 172. Similarly, the resonator pole 164 likewise has two symmetrical portions with respect to spacing and resonant coupling about the resonator pole 172 based on the spacing between the seventh conductive ridge portion 174 and the eighth conductive ridge portion 176. Therefore, the impedance at each of the first end 157 and the second end 159 of the programmable tunable filter waveguide 151 is balanced with respect to each other, and can thus be matched to associated coupled transmission media. In addition, because the resonant coupling is substantially greater at each of the first end 157 and the second end 159, signal nodes of the signal in the desired frequency pass-band defined by the resonator poles 164, 170, and 172 are more closely coupled to the first end 157 and the second end 159. Accordingly, the first configuration 150 can result in a substantially effective out-of-band frequency rejection of the signal. Furthermore, because the portions of the resonator poles 164 and 170 are symmetrical with respect to length, the desired frequency pass-band is substantially unaffected as the signal is affected by each portion of the resonator poles 164 and 170 substantially the same.

The second configuration 152 of the programmable tunable filter waveguide 151 is substantially the same as the first configuration 150 with regard to conductive and resonant coupling. However, the second configuration 152 includes a resonator pole 178 having two portions, each separated by a length of λ₄/2, a resonator pole 180 having two portions, each separated by a length of λ₅/2, and a resonator pole 182 separated by a length of λ₆/2. The lengths λ₄, λ₅, and λ₆ are wavelengths corresponding to frequencies in a desired frequency pass-band that is defined by the resonator poles 178, 180, and 182. The resonator poles 178, 180, and 182 are each demonstrated in the example of FIG. 4 as having a substantially shorter length than the resonator poles 164, 170, and 172 of the first configuration 150, and thus correspond to shorter wavelengths of correspondingly higher frequencies. Therefore, the frequency pass-band of the second configuration 152 can be substantially greater than the frequency pass-band defined by the first configuration 150.

In a similar manner, the third configuration 154 of the programmable tunable filter waveguide 151 includes a resonator pole 184 having two portions, each separated by a length of λ₇/2, a resonator pole 186 having two portions, each separated by a length of λ₈/2, and a resonator pole 186 separated by a length of λ₉/2. The resonator poles 184, 186, and 188 are each demonstrated in the example of FIG. 4 as having a substantially shorter length than the resonator poles 178, 180, and 182 of the second configuration 152, and thus correspond to shorter wavelengths of correspondingly higher frequencies. Therefore, the frequency pass-band of the third configuration 154 can be substantially greater than the frequency pass-band defined by the second configuration 152.

It is to be understood that, in the example of FIG. 4, the distances λ_{X}/2 are intended to be drawn loosely to scale relative to each other. However, it is also to be understood that each of the resonator poles that have different wavelength variables are intended to have different wavelengths for the purpose of the discussion of the example of FIG. 4. Therefore, the resonator poles 164, 170, 172, 178, 180, 182, 184, 186, and 188 are not intended to be limited to the wavelengths depicted in the example of FIG. 4, and are not intended to be of the same wavelength relative to each other.

FIG. 5 illustrates an example of a frequency response graph 200 of the first configuration 150, the second configuration 152, and the third configuration 154 of the programmable tunable filter waveguide 151 of the example of FIG. 4 in accordance with an aspect of the invention. The frequency response graph 200 includes a first curve 202 that corresponds to the first configuration 150, a second curve 204 that corresponds to the second configuration 152, and a third curve 206 that corresponds to the third configuration 154. In the example of FIG. 5, the first curve 202 demonstrates a frequency pass-band between approximately 17.5 GHz and 19.5 GHz, the second curve 204 demonstrates a frequency pass-band between approximately 21.5 GHz and 23.5 GHz, and the third curve 206 demonstrates a frequency pass-band between approximately 25.5 GHz and 27.5 GHz. Thus, as described above in the example of FIG. 4, the third configuration 154 of the programmable tunable filter waveguide 151 is configured with a substantially greater frequency pass-band than the second configuration 152, which is configured with a substantially greater frequency pass-band than the first configuration 150.

In addition, as also described above in the example of FIG. 4, each of the configurations 150, 152, and 154 are configured with high resonant coupling at each end of the programmable tunable filter waveguide 151. Therefore, each of the configurations 150, 152, and 154 can result in a substantially effective out-of-band frequency rejection of the signal, as demonstrated by the sharp out-of-band power loss of each of the curves 202, 204, and 206 in the example of FIG. 5. Adjustments to the resonant coupling of the programmable tunable filter waveguide 151 can be made based on the switch configuration to change the out-of-band slope of the curves 202, 204, and 206. In addition, although the example of FIG. 5 demonstrates substantially no losses in the frequency pass-band of each of the curves 202, 204, and 206, it is to be understood that the frequency pass-band could be subject to loss based on insertion losses and/or the configuration of the switches. Furthermore, it is to be understood that the programmable tunable filter waveguide 151 is not limited to the configurations 150, 152, and 154 in the example of FIG. 4, but can include more or less poles than three, each with different amounts of resonant coupling. Accordingly, the programmable tunable filter waveguide 151 can be configured in any of a variety of ways.

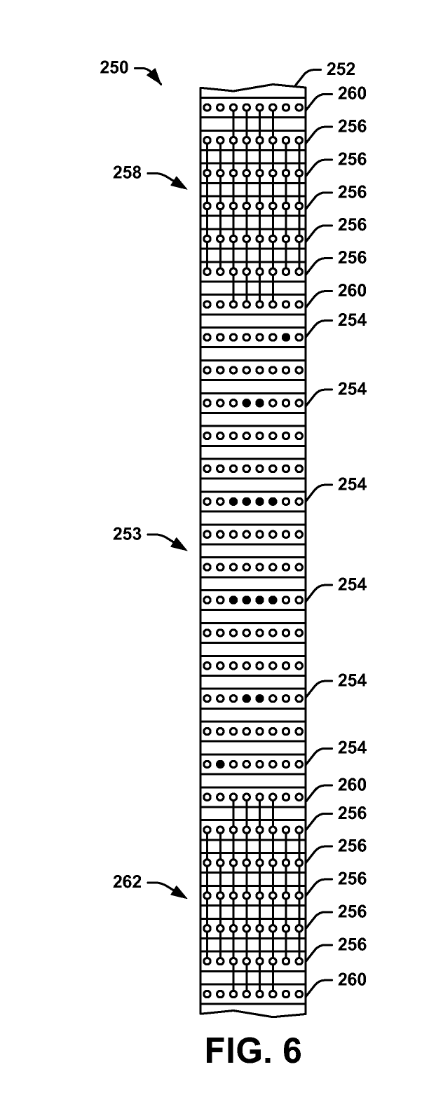

FIG. 6 illustrates an example of a configuration 250 of a programmable tunable filter waveguide 252 in accordance with an aspect of the invention. The programmable tunable filter waveguide 151 of which the configuration 250 represents can be substantially similar to the portion of the programmable tunable filter waveguide 100 in the example of FIG. 3. Therefore, reference is to be made to the example of FIG. 3 in the discussion of the example of FIG. 6.

The configuration 250 of the programmable tunable filter waveguide 252 includes a slow-wave waveguide portion 253. The slow-wave waveguide portion 253 includes a plurality of conductive ridge portions 254 that include activated switches, as demonstrated similar to the example of FIG. 4, for coupling the conductive ridge portions 254 to respective conductive shunts (not shown). Therefore, the conductive ridge portions 254 are conductively coupled to a conductive outer surface, such as the conductive bottom surface 64 in the example of FIG. 2. Similar to as described above, the conductive ridge portions 254 are conductively coupled to the conductive outer surface to form one or more resonator poles defining a frequency pass-band, with the number of activated switches for each of the conductive ridge portions 254 being determinative of the amount of resonant coupling for the signal propagating through the programmable tunable filter waveguide 252.

The configuration 250 of the programmable tunable filter waveguide 252 also includes a first plurality of conductive ridge portions 256 that are conductively coupled together via a plurality of ridge connection switches, demonstrated in the example of FIG. 6 as solid lines connecting open circles. By conductively coupling the first group of adjacent conductive ridge portions 256 together, the physical slow-wave waveguide structure of the programmable tunable filter waveguide 252 can be reconfigured to simulate a non-slow-wave ridged waveguide portion 258. The length of the simulated non-slow-wave ridged waveguide portion 258 can be controlled not only by the number of the first group of adjacent conductive ridge portions 256 that are coupled together, but also by the number of the ridge connection switches used to couple a set of adjacent conductive ridge portions 256 together. Specifically, in the example of FIG. 6, conductive ridge portions 260 are demonstrated as coupled to an adjacent conductive ridge portion 256 via only four ridge connection switches, as opposed to all of them. As such, the length of the simulated non-slow-wave ridged waveguide portion 258 may not be limited to just digital lengths between adjacent coupled conductive ridge portions 256. Instead, by activating less than all of the ridge connection switches to interconnect adjacent conductive ridge portions 256, a length that is a fraction of the length between the adjacent conductive ridge portions can be included in the total length of the simulated non-slow-wave ridged waveguide portion 258.

The configuration 250 of the programmable tunable filter waveguide 252 also includes a second simulated non-slow-wave ridged waveguide portion 262 which is configured substantially the same as the non-slow-wave ridged waveguide portion 258. The simulated non-slow-wave ridged waveguide portions 258 and 262 are thus interleaved with the slow-wave waveguide portion 253. The programmable tunable filter waveguide 252 can thus include alternating sections of simulated non-slow-wave ridged waveguide portions, such as the simulated non-slow-wave ridged waveguide portions 258 and 262, and slow-wave waveguide portions, such as the slow-wave waveguide portion 253.

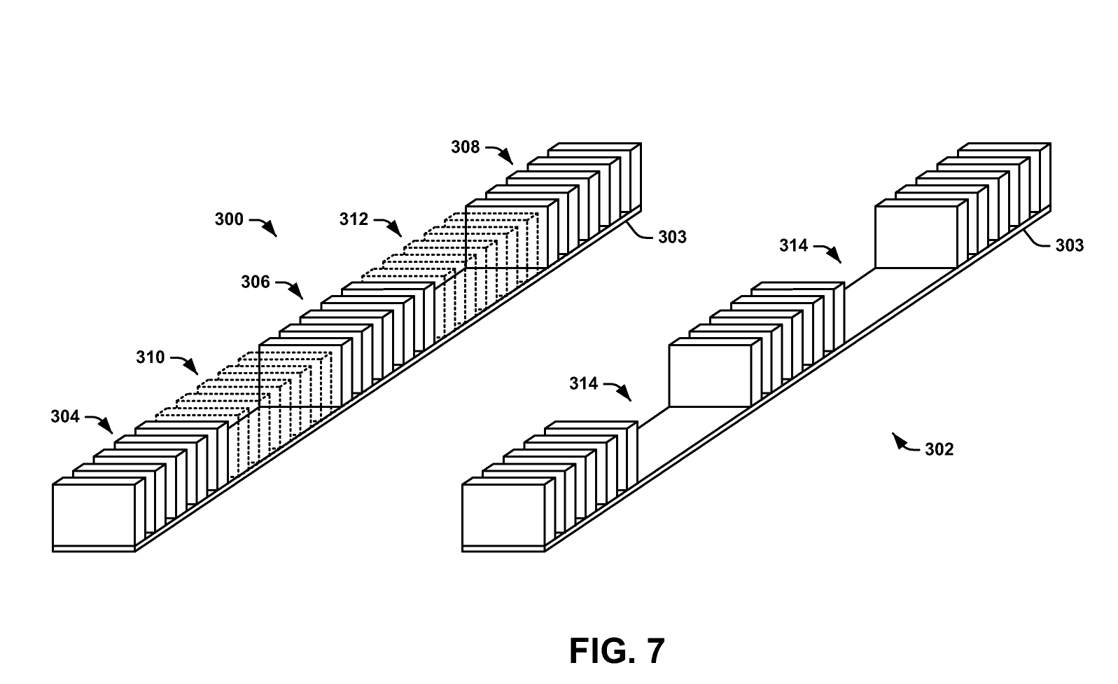

FIG. 7 illustrates a first diagrammatic example 300 and a second diagrammatic example 302 of a programmable tunable filter waveguide 303, which can be configured substantially similar to the programmable tunable filter waveguide 252 in the example of FIG. 6, in accordance with an aspect of the invention. It is to be understood that, although it is not depicted in the example of FIG. 7, the programmable tunable filter waveguide 303 may also include a conductive straight ridged waveguide structure having a pair of conductive sidewalls and a conductive top portion, such as described above in the example of FIG. 2.

Each of the first diagrammatic example 300 and the second diagrammatic example 302 demonstrate a first slow-wave waveguide portion 304, a second slow-wave waveguide portion 306, and a third slow-wave waveguide portion 308. Each of the slow-wave waveguide portions 304, 306, and 308 can include conductive ridge portions that are coupled to a conductive outer surface of the programmable tunable filter waveguide 303, thus generating one or more resonator poles for a signal propagating through the programmable tunable filter waveguide 303. In addition, each of the slow-wave waveguide portions 304, 306, and 308 can have arrangements of resonator poles that differ relative to each other.

The first diagrammatic example 300 also demonstrates a first simulated non-slow-wave ridged waveguide portion 310 and a second simulated non-slow-wave ridged waveguide portion 312, demonstrated in the example of FIG. 7 as dashed lines to depict the conductive ridge portions that are conductively coupled to each other. Similar to as described above regarding the example of FIG. 6, the simulated non-slow-wave ridged waveguide portions 310 and 312 are thus interleaved with the slow-wave waveguide portions 304, 306, and 308. Because the coupling of adjacent conductive ridge portions simulates a non-slow-wave ridged waveguide portion, the second diagrammatic portion 302 of the programmable tunable filter waveguide 304 demonstrates a physical representation of the first diagrammatic example 300 of the programmable tunable filter waveguide 304. Specifically, the second diagrammatic example 302 demonstrates actual non-slow-wave ridged waveguide portions 314 in place of the simulated non-slow-wave ridged waveguide portions 310 and 312. Thus, the example of FIG. 7 demonstrates the effect of coupling adjacent conductive ridge portions together, as it would affect the signal propagating through the programmable tunable filter waveguide 303.

The interleaving of simulated non-slow-wave ridged waveguide portions, such as the non-slow-wave ridged waveguide portions 258 and 262 in the example of FIG. 6, with slow-wave waveguide portions, such as the slow-wave waveguide portion 253 in the example of FIG. 6, forms a low-pass filter that is connected in series with the resonator poles of the slow-wave waveguide portions. As a result, the low-pass filter is configured to remove undesired harmonic frequencies associated with the desired frequency pass-band from the signal. Specifically, because the high frequency harmonic components cannot effectively propagate through the simulated slow-wave ridged waveguide portions, the high-frequency harmonic components are prevented from propagating through the programmable tunable waveguide filter. Therefore, only the desired frequency pass-band can pass through the programmable tunable filter waveguide.

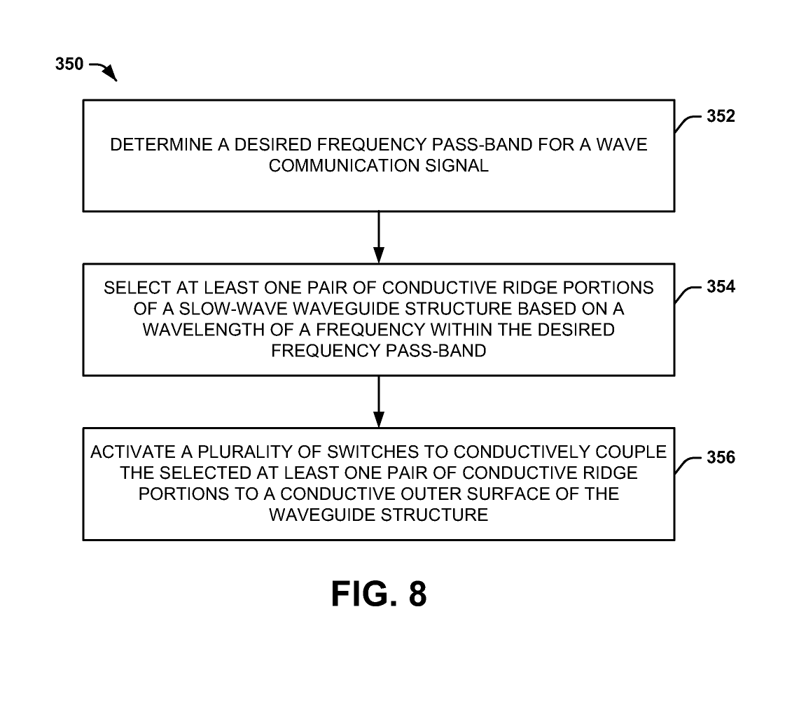

In view of the foregoing structural and functional features described above, methodologies in accordance with various aspects of the present invention will be better appreciated with reference to FIG. 8. While, for purposes of simplicity of explanation, the methodology of FIG. 8 is shown and described as executing serially, it is to be understood and appreciated that the present invention is not limited by the illustrated order, as some aspects could, in accordance with the present invention, occur in different orders and/or concurrently with other aspects from that shown and described herein. Moreover, not all illustrated features may be required to implement a methodology in accordance with an aspect the present invention.

FIG. 8 illustrates an example of a method 350 for filtering signals in accordance with an aspect of the invention. As an example, the signals can be micrometer and/or millimeter wave signals. At 352, a desired frequency pass-band for a signal is determined. The desired frequency pass-band can correspond to a frequency pass-band that is normally implemented in a typical channelized filter bank. At 354, at least one pair of conductive ridge portions of a slow-wave waveguide structure is selected based on a wavelength of a frequency within the desired frequency pass-band. The selected at least one pair of conductive ridge portions can be separated by a length of λ/2, where λ is a wavelength of the frequency within the desired frequency pass-band.

At 356, a plurality of switches are activated to conductively couple the selected at least one pair of conductive ridge portions to a conductive outer surface of the waveguide structure. The conductive outer surface can be a conductive bottom surface of the waveguide structure. The at least one pair of conductive ridge portions that are conductively coupled to the outer surface can form a respective at least one resonator pole of a frequency that is within the desired frequency pass-band. An amount of resonant coupling of the at least one resonator pole can be controlled by the number of switches that are activated to couple each of the conductive ridge portions to the conductive outer surface.

What has been described above includes exemplary implementations of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications, and variations that fall within the scope of the appended claims.

What is claimed is:

1. A waveguide comprising:
an elongated member having a conductive bottom surface and a hollow channel, the hollow channel being defined by a first conductive sidewall, a second conductive sidewall, and a conductive inner surface;
a plurality of conductive ridge portions projecting from the conductive inner surface and extending between the first conductive sidewall and the second conductive sidewall, the plurality of conductive ridge portions being conductive and partitioning the hollow channel into a plurality of hollow recesses; and
a plurality of switches associated with each of at least one of the plurality of conductive ridge portions, at least one of the plurality of switches associated with a respective one of the plurality of conductive ridge portions being activated to couple the respective one of the plurality of conductive ridge portions to the conductive bottom surface.

2. The waveguide of claim 1, wherein each of the plurality of switches is coupled to one of a respective plurality of conductive shunts coupled to the conductive bottom surface, such that, upon activation, each of the plurality of switches couples one of the plurality of conductive ridge portions to the conductive bottom surface via a respective one of the plurality of shunts.

3. The waveguide of claim 2, wherein each of the plurality of conductive shunts coupled to each of the respective plurality of switches associated with a given one of the plurality of conductive ridge portions is located in a respective one of the plurality of hollow recesses adjacent to the given one of the plurality of conductive ridge portions.

4. The waveguide of claim 1, wherein at least one of the plurality of switches associated with a first one of the plurality of conductive ridge portions and at least one of the plurality of switches associated with a second one of the plurality of conductive ridge portions are activated to form a resonator pole for a given frequency of a wave signal propagating through the waveguide, the first one of the plurality of conductive ridge portions and the second one of the plurality of conductive ridge portions being separated by a distance of approximately λ₁/2, wherein λ₁ is a wavelength of the wave signal corresponding to the given frequency.

5. The waveguide of claim 4, wherein an amount of resonant coupling of the wave signal to the resonator pole is controlled by a quantity of the plurality of switches associated with the first one of the plurality of conductive ridge portions that are activated and a quantity of the plurality of switches associated with the second one of the plurality of conductive ridge portions that are activated.

6. The waveguide of claim 4, wherein the resonator pole is a first resonator pole, and wherein at least one of the plurality of switches associated with at least one additional conductive ridge portion of the plurality of conductive ridge portions is activated to form at least one additional resonator pole, the first resonator pole and the at least one additional resonator pole defining a frequency pass-band of the wave signal propagating through the waveguide.

7. The waveguide of claim 6, wherein each of the first resonator pole and the at least one additional resonator pole are configured in series with respect to each other, such that a given one of the plurality of conductive ridge portions is coupled to the conductive bottom surface for the formation of two adjacent resonator poles.

8. The waveguide of claim 7, wherein each of the at least one additional resonator pole comprises two non-adjacent resonator pole portions symmetrical with respect to the first resonator pole, each of the two non-adjacent resonator pole portions comprising a pair of conductive ridge portions separated by approximately λ_{X}/2, wherein λ_{X} is a wavelength of the wave signal corresponding to each respective frequency of the at least one additional resonator pole.

9. The waveguide of claim 8, wherein each of the two non-adjacent resonator pole portions of the at least one additional resonator pole has a respective resonant coupling amount associated with each of the plurality of conductive ridge portions from which each of the at least one additional resonator pole is formed, the respective resonant coupling amount being symmetrical with respect to the first resonator pole.

10. The waveguide of claim 1, wherein the plurality of switches associated with each of the at least one of the plurality of conductive ridge portions is a first plurality of switches, the waveguide further comprising a second plurality of switches associated with each of at least one of the plurality of conductive ridge portions, at least one of the second plurality of switches associated with a respective one of the plurality of conductive ridge portions being activated to couple the respective one of the plurality of conductive ridge portions to an adjacent one of the plurality of conductive ridge portions to simulate a straight ridged waveguide portion.

11. The waveguide of claim 10, wherein the plurality of conductive ridge portions comprises a first plurality of conductive ridge portions and a second plurality of conductive ridge portions, the first plurality of conductive ridge portions comprising at least two subsets that are interleaved with respect to the first plurality of conductive ridge portions, and wherein at least one of the second plurality of switches associated with each of the first plurality of conductive ridge portions is activated and at least one of the second plurality of switches associated with each of the second plurality of conductive ridge portions is deactivated to simulate a plurality of straight ridged waveguide portions.

12. The waveguide of claim 1, wherein the elongated member comprises a first end coupled to a first transmission line and a second end coupled to a second transmission line, and wherein at least one of the plurality of switches associated with at least one of the plurality of conductive ridge portions is activated to substantially match an impedance of at least one of the first end with the first transmission line and the second end with the second transmission line.

13. A method for filtering a wave signal in an elongate waveguide structure, the method comprising:
determining a desired frequency pass-band for the wave signal;
selecting at least one pair of a plurality of conductive ridge portions disposed along a longitudinal surface of the elongate waveguide structure, the selected at least one pair of the plurality of conductive ridge portions corresponding to a respective at least one resonator pole based on a physical separation of the at least one pair of the plurality of conductive ridge portions relative to a wavelength of the wave signal that is associated with the respective at least one resonator pole, the respective at least one resonator pole corresponding to a respective at least one frequency within the desired frequency pass-band; and
activating a plurality of switches configured to conductively couple the selected at least one pair of the plurality of conductive ridge portions to a conductive outer surface of the elongate waveguide structure.

14. The method of claim 13, wherein activating the plurality of switches comprises conductively coupling each of the selected at least one pair of the plurality of conductive ridge portions to at least one conductive shunt that is coupled to the conductive outer surface of the elongate waveguide structure.

15. The method of claim 13, wherein selecting the at least one pair of the plurality of conductive ridge portions comprises selecting at least one pair of the plurality of conductive ridge portions that is separated by a distance of λ/2, wherein λ is a respective wavelength of the wave signal corresponding to the respective at least one frequency within the desired frequency pass-band.

16. The method of claim 13, wherein activating the plurality of switches comprises controlling an amount of resonant coupling of the wave signal to the at least one resonator pole based on a quantity of the plurality of switches activated to couple the at least one pair of the plurality of conductive ridge portions to the conductive outer surface of the elongate waveguide structure.

17. The method of claim 13, wherein the plurality of switches is a first plurality of switches, the method further comprising activating a second plurality of switches configured to couple at least one adjacent pair of the plurality of conductive ridge portions together to provide filtering of harmonic frequencies associated with the desired frequency pass-band.

18. The method of claim 13, further comprising activating at least one of the plurality of switches to substantially match an impedance of at least one of a first end of the elongate waveguide structure with a first transmission line coupled to the first end of the elongate waveguide structure and a second end of the elongate waveguide structure with a second transmission line coupled to the second end of the elongate waveguide structure.

19. A wave signal waveguide comprising:
means for slowing propagation of a wave signal from a first end of the waveguide to a second end of the waveguide; and
means for switchably generating at least one resonator pole associated with a respective at least one frequency of the wave signal, the at least one resonator pole defining a frequency pass-band for the wave signal.

20. The waveguide of claim 19, wherein the means for switchably generating the at least one resonator pole comprises means for substantially matching an impedance of at least one of the first end of the waveguide with an associated first transmission line and the second end of the waveguide with an associated second transmission line.

21. The waveguide of claim 19, wherein the means for switchably generating the at least one resonator pole comprises means for controlling an amount of resonant coupling of the wave signal to the at least one resonator pole.

22. The waveguide of claim 19, wherein the means for switchably generating the at least one resonator pole comprises means for switchably generating a low-pass filter connected in series to the at least one resonator pole.
